(19) United States
(12) Patent Application Publication
(10) Pub. No.: US 2022/0243595 A1
(43) Pub. Date: Aug. 4, 2022

(54) STEPLESS SPEED REGULATING HANDY DUST CLEANER

(71) Applicant: Dongguan Yateng Electronics Co., Ltd, Dongguan (CN)

(72) Inventor: Song Li, Ganzhou (CN)

(21) Appl. No.: 17/165,891

(22) Filed: Feb. 2, 2021

(51) Int. Cl. F01D 5/14; B01D 46/00; B01D 46/10; B01D 46/42; B01D 39/12; B08B 5/02; B08B 13/00; F04D 29/28

(52) U.S. Cl. CPC F01D 5/141; B01D 46/0049; B01D 46/10; B01D 46/4245; B01D 2279/55; B08B 5/02; B08B 13/00; F04D 29/281; B01D 2273/30; B01D 39/12

(57) ABSTRACT

A stepless speed regulatable handy dust cleaner is disclosed, which includes: a housing, a battery, a blower mechanism, a control module, an air filter mechanism, and a blow pipe. A side of the housing is provided with an air outlet opening, and another side of the housing is provided with an air filter opening. The housing includes a first mounting shell and a second mounting shell, each of which includes a handgrip part and an air outlet part. The first mounting shell is provided with a knob slot, where a knob is provided. The blower mechanism includes a motor, a motor board, a blower casing and a fan blade. The motor is drivingly connected to the fan blade. The battery, the control module and the motor are electrically connected to each other. When the knob is rotated clockwise, the air volume and flow pressure gradually increase. When the knob is rotated counterclockwise, and the air volume and flow pressure gradually decrease.

### TECHNICAL FIELD

The present disclosure relates to the field of household goods, and more particularly, to a stepless speed regulatable handy dust cleaner.

### BACKGROUND

In daily life, there are dusts in many corners, such as gaps in a computer cases, a keyboard or a vent of an air-conditioning. It is difficult to remove the dusts in these places with ordinary cleaning tools. A blower dust cleaner can blow the dust in the gaps. However, the existing blower dust cleaner has a large volume and is limited by a power supply, and thus is difficult for carrying out and handheld operation. In addition, the existing blower dust cleaner usually has only a few gears, which cannot be adjusted according to needs.

### SUMMARY

In order to overcome the above disadvantages, the present disclosure provides a stepless speed regulatable handy dust cleaner, and the technical scheme is as follows.

A stepless speed regulatable handy dust cleaner includes a housing, a battery, a blower mechanism, a control module, a filter mechanism, and a blow pipe. The battery, the blower mechanism, and the control module are mounted inside the housing. A side of the housing is provided with an air outlet opening, and another side of the housing is provided with an air filter opening. The blow pipe is mounted to the air outlet opening, and the air filter mechanism is mounted to the air filter opening. The housing includes a first mounting shell and a second mounting shell. The first mounting shell is mounted on a top of the second mounting shell. Each of the first mounting shell and the second mounting shell includes a handgrip part and an air outlet part. The blower mechanism is mounted in the air outlet part. The battery and the control module are mounted in the handgrip part. The first mounting shell is provided with a knob slot, a knob is disposed in the knob slot, and the knob is connected to the control module. The blower mechanism includes a motor, a motor board, a blower casing and a fan blade. The motor board is mounted to the housing. The blower casing is mounted on the motor board. The motor and the fan blade are both mounted inside the blower casing. A side of the blower casing extends to the air outlet opening. The motor is drivingly connected to the fan blade. The battery, the control module and the motor are electrically connected to each other.

Further, the blower casing includes a first casing and a second casing, the first casing is mounted to a top of the second casing, a positioning pole is provided in the second casing, the motor is mounted on the second casing, and the motor and the positioning pole fit each other in a positional restriction manner.

Alternatively, the second casing is made of a cast aluminum material.

Further, the air filter mechanism includes an iron filter net and a side cover, the side cover is mounted on the housing, the iron filter net is mounted on the side cover, and the side cover is on an exterior side of the filter iron net.

Further, an aluminum ring is mounted on an exterior end of the handgrip part, and the aluminum ring is located outside the first mounting shell and the second mounting shell.

Further, each of a side of the first mounting shell and a side of the second mounting shell is formed with a concentration part, the air outlet opening runs through the concentration part, the blower pipe is inserted and mounted on the concentration part, the concentration part is mounted with an iron ring, and the iron ring is located outside the concentration part.

Alternatively, the fan blade is of an umbrella-shaped structure.

Compared with the existing art, the present disclosure has the following beneficial effects.

By pressing the knob, the control module is started, such that the fan blade of the motor rotates counterclockwise and throws out air to form an air flow. The air flow is blown out from the air outlet opening to the blow pipe. When the knob is rotated clockwise, the air volume and flow pressure gradually increase. When the knob is rotated counterclockwise, and the air volume and flow pressure gradually decrease. Therefore, the stepless speed regulation of the dust cleaner can be achieved. The dust cleaner is powered by the battery and thus is carried out easily. The dust cleaner is provided with a handgrip part, facilitating hand holding.

### BRIEF DESCRIPTION OF DORIGINALINGS

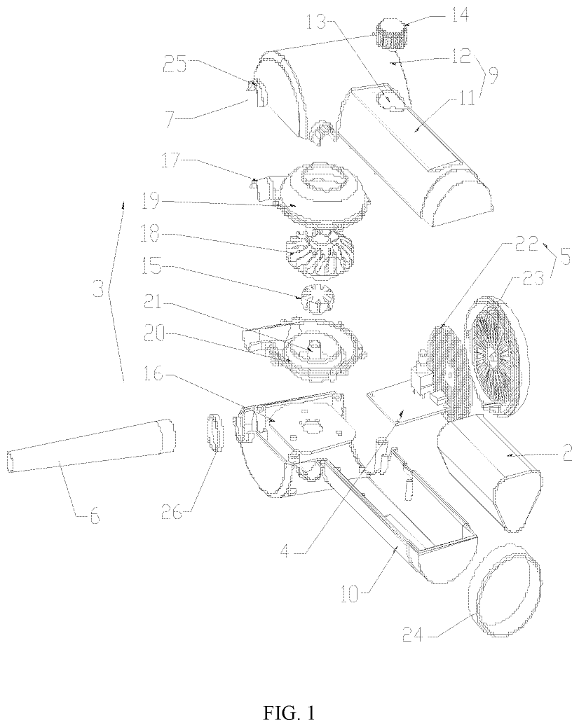

FIG. 1 is an exploded view of a stepless speed regulatable handy dust cleaner according to the present disclosure.

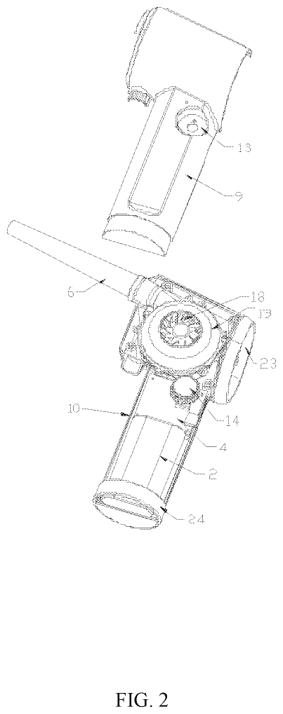

FIG. 2 is an assembled view of a stepless speed regulatable handy dust cleaner according to the present disclosure.

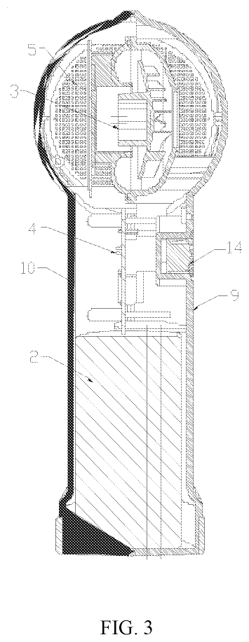

FIG. 3 is a sectional view of a stepless speed regulatable handy dust cleaner according to the present disclosure.

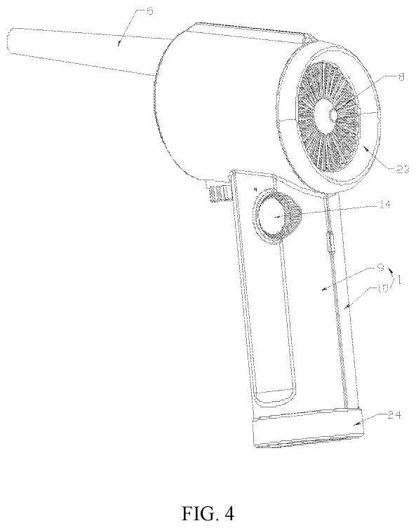

FIG. 4 is a perspective view of a stepless speed regulatable handy dust cleaner according to the present disclosure.

Reference sign list: 1 housing; 2 battery; 3 blower mechanism; 4 control module; 5 air filter mechanism; 6 blow pipe; 7 air outlet opening; 8 air filter opening; 9 first mounting shell; 10 second mounting shell; 11 handgrip part; 12 air outlet part; 13 knob slot; 14 knob; 15 motor; 16 motor board; 17 blower casing; 18 fan blade; 19 first casing; 20 second casing; 21 positioning pole; 22 filter iron net; 23 side cover; 24 aluminum ring; 25 concentration part; 26 iron ring.

### DESCRIPTION OF EMBODIMENTS

As shown in FIG. 1 to FIG. 4, a stepless speed regulatable handy dust cleaner includes a housing 1, a battery 2, a blower mechanism 3, a control module 4, an air filter mechanism 5, and a blow pipe 6. The battery 2, the blower mechanism 3, and the control module 4 are mounted inside the housing 1. A side of the housing 1 is provided with an air outlet opening 7. Another side of the housing 1 is provided with an air filter opening 8. The blow pipe 6 is mounted to the air outlet opening 7. The air filter mechanism 5 is mounted to the air filter opening 8. The housing 1 includes a first mounting shell 9 and a second mounting shell 10. The first mounting shell 9 is mounted on a top of the second mounting shell 10. Each of the first mounting shell 9 and the second mounting shell 10 includes a handgrip part 11 and an air outlet part 12. The blower mechanism 3 is mounted in the air outlet part 12. The battery 2 and the control module 4 are both mounted in the handgrip part 11. The first mounting shell 9 is provided with a knob slot 13. A knob 14 is disposed in the knob slot 13, and the knob 14 is connected to the control module 4. The blower mechanism 3 includes a motor 15, a motor board 16, a blower casing 17 and a fan blade 18. The motor board 16 is mounted to the housing 1. The blower casing 17 is mounted on the motor board 16, and the motor 15 and the fan blade 18 are both mounted inside the blower casing 17. A side of the blower casing 17 extends to the air outlet opening 7. The motorl5 is drivingly connected to the fan blade 18. The battery 2, the control module 4 and the motor 15 are electrically connected to each other.

The dust cleaner is further illustrated. The knob 14 is pressed, the control module 4 is started, such that the fan blade 18 of the motor 15 rotates counterclockwise to throw out air to form an air flow. The air flow is blown out from the air outlet opening 7 to the blow pipe 6. The knob 14 is rotated clockwise, and the air volume and flow pressure gradually increase. The knob 14 is rotated counterclockwise, and the air volume and flow pressure gradually decrease. Therefore, the stepless speed regulation of the dust cleaner can be achieved. The dust cleaner is powered by the battery 2, and thus is carried out easily. The dust cleaner is provided with a handgrip part 11, facilitating hand holding.

Further, the blower casing 17 includes a first casing 19 and a second casing 20, and the first casing 19 is mounted to a top of the second casing 20. A positioning pole 21 is provided in the second casing 20. The motor 15 is mounted on the second casing 20. The motor 15 and the positioning pole 21 fit each other in a positional restriction manner. With the positional restriction of the motor 15 and the positioning pole 21, the stability of the installation of the motor 15 and the fan blade 18 is enhanced.

Alternatively, the second casing 20 is made of a cast aluminum material. The second casing 20 is made of the cast aluminum, which helps the heat dissipating of the motor board 16 and the motor 15. In addition, there is air flow in the blower casing 17, which also can take away the heat generated by the motor board 16 and the motor 15, and thus the motor 15 can operates more efficiently.

Further, the air filter mechanism 5 includes an iron filter net 22 and a side cover 23. The side cover 23 is mounted on the housing 1, the iron filter net 22 is mounted on the side cover 23, and the side cover 23 is on an exterior side of the iron filter net 22. The air flow outside the housing 1 is filtered by the iron filter net 22 and then blown out from the air outlet opening 7, which can reduce the dust blown out by the dust cleaner and enhance the dust removal effect.

Further, an aluminum ring 24 is mounted on an exterior end of the handgrip part 11, and the aluminum ring 24 is located outside the first mounting shell 9 and the second mounting shell 10. The aluminum ring 24 is mounted to encircle the periphery of the handgrip part 11, the mounting tightness of the first mounting shell 9 and the second mounting shell 10 is enhanced.

Further, each of a side of the first mounting shell 9 and a side of the second mounting shell 10 is formed with a concentration part 25, the air outlet opening 7 runs through the concentration part 25, the blower pipe 6 is inserted and mounted on the concentration part 25, the concentration part 25 is mounted with an iron ring 26, and the iron ring 26 is located outside the concentration part 25. The concentration part 25 can enhance the concentration of the air flow, and the iron ring 26 can prevent the air flow from leaking from the side of the concentration part 25.

Alternatively, the fan blade 18 is of an umbrella-shaped structure. With the design of the umbrella-shaped structure, the air flow enters through the umbrella-shaped surface, and is directly discharged along the tangential direction of the umbrella-shaped structure, thereby enhancing the blowing effect.

Based on the structures and principles disclosed in the present disclosure, those skilled in the art can obtain various other corresponding changes and modifications, and all these changes and modifications are within the protection scope of the present disclosure.

What is claimed is:

1. A stepless speed regulatable handy dust cleaner comprising:
a housing;
a battery;
a blower mechanism;
a control module;
an air filter mechanism; and
a blow pipe,
wherein the battery, the blower mechanism, and the control module are mounted inside the housing, a side of the housing is provided with an air outlet opening, another side of the housing is provided with an air filter opening, the blow pipe is mounted to the air outlet opening, the air filter mechanism is mounted to the air filter opening, the housing comprises a first mounting shell and a second mounting shell, the first mounting shell is mounted on a top of the second mounting shell, each of the first mounting shell and the second mounting shell comprises a handgrip part and an air outlet part, the blower mechanism is mounted in the air outlet part, the battery and the control module are mounted in the handgrip part, the first mounting shell is provided with a knob slot, a knob is disposed in the knob slot, the knob is connected to the control module, the blower mechanism comprises a motor, a motor board, a blower casing and a fan blade, the motor board is mounted to the housing, the blower casing is mounted on the motor board, the motor and the fan blade are both mounted inside the blower casing, a side of the blower casing extends to the air outlet opening, the motor is drivingly connected to the fan blade, and the battery, the control module and the motor are electrically connected to each other.

2. The stepless speed regulatable handy dust cleaner of claim 1, wherein the blower casing comprises a first casing and a second casing, the first casing is mounted to a top of the second casing, a positioning pole is provided in the second casing, the motor is mounted on the second casing, and the motor and the positioning pole fit each other in a positional restriction manner.

3. The stepless speed regulatable handy dust cleaner of claim 2, wherein the second casing is made of a cast aluminum material.

4. The stepless speed regulatable handy dust cleaner of claim 1, wherein the air filter mechanism comprises an iron filter net and a side cover, the side cover is mounted on the housing, the iron filter net is mounted on the side cover, and the side cover is on an exterior side of the filter iron net.

5. The stepless speed regulatable handy dust cleaner of claim 1, wherein an aluminum ring is mounted on an exterior end of the handgrip part, and the aluminum ring is located outside the first mounting shell and the second mounting shell.

6. The stepless speed regulatable handy dust cleaner of claim 1, wherein each of a side of the first mounting shell and a side of the second mounting shell is formed with a concentration part, the air outlet opening runs through the concentration part, the blower pipe is inserted and mounted on the concentration part, the concentration part is mounted with an iron ring, and the iron ring is located outside the concentration part.

7. The stepless speed regulatable handy dust cleaner of claiml, wherein the fan blade is of an umbrella-shaped structure.
